(19) United States
(12) Patent Application Publication
(10) Pub. No.: US 2006/0095777 A1
(43) Pub. Date: May 4, 2006

(54) Contract execution system and process

(76) Inventors: Joshua J. Brekke, Aliso Viejo, CA (US); Lauree A. Brekke, Fargo, ND (US); Kaira M. Brekke, Aliso Viejo, CA (US); Katie A. Brekke, Aliso Viejo, CA (US); James S. Brekke, Fargo, ND (US); Kelly B. Wentz, Fargo, ND (US)

Correspondence Address: Dennis W. Beech;LAW OFFICES OF DENNIS W. BEECH, Suite C-2, 19900 Beach Blvd., Huntington Beach, CA, 92648, US

(21) Appl. No.: 11/262,149

(22) Filed: Oct. 28, 2005

Related U.S. Application Data
(60) Provisional application No. 60/624,087, filed on Nov. 1, 2004.
(60) Provisional application No. 60/649,595, filed on Feb. 4, 2005.

(51) Int. Cl. H04L 9/00

(52) U.S. Cl. 713/176

(57) ABSTRACT

The present invention may be used for contract preparation and contract performance payment. A request for performance may be initiated to a provider by a buyer. A contract may be created by a provider at a first system terminal of a central operating and data base element for the performance. The contract may be transmitted with a signing instruction to the buyer. The signing instruction may be implemented to log on to a system terminal and to enter a user identification for reviewing the contract and for signing the contract. The contract may be performed by the provider and a bill may be transmitted to the buyer at a system terminal. A payment may be released for the contract to the provider at a system terminal.

This application claims the benefit of U.S. Provisional Application No. 60/624,087, filed Nov. 1, 2004 and U.S. Provisional Application No. 60/649,595, filed Feb. 4, 2005.

### BACKGROUND OF THE INVENTION

This invention relates to methods and processes for preparation of contract documents, monitoring of contract progress and authorizing payment of funds for performing on contracts. The new method and system may use a central operating and data base element for creation of contract documents, for transmitting a contract document with instructions for executing or signing the contract document, for electronic signature of a contract document, for recording contract performance and for authorizing and paying funds for contract performance. The method and system may allow preparation of various status reports by users to monitor multiple contractor or subcontractor activities associated with contracts.

The existing methods and systems for contract process, particularly in the construction industry as for example the lien waiver documents associated with construction loans, may be cumbersome and time consuming as much of the process may not be automated. As an example, when a contractor obtains a construction loan with an FDIC chartered bank the lender is subject to strict FDIC guidelines. One problem for banks, examiners, title companies, contractors and others may be facilitating lien waiver for a construction project throughout the loan period. The lien waivers are required for subcontractors, suppliers and others who may be paid from loan funds for work on a construction project. This may protect the FDIC and banks collateral for a loan to avoid fraud.

There may be three ways to obtain a signed lien waiver for work performed. One method may be to hand deliver a payment to a subcontractor or supplier and obtain a signature on a lien waiver document at the same time. Another method may be to mail a check or pay by credit card telephonically or on the Internet. The lien waiver may be mailed or facsimiled to the subcontractor or supplier for them to sign and return the document. This may require a trustworthy subcontractor or supplier to return the document. Yet another method may be to put the lien waiver wording on a check for payment and use the cashed check as agreement to the lien waiver. This method may be of questionable legality.

### SUMMARY OF THE INVENTION

The present invention is directed to systems and methods for contract preparation and performance payment. A request for performance may be initiated to a provider by a buyer. A contract may be created by a provider at a first system terminal of a central operating and data base element for the performance. The contract may be transmitted with a signing instruction to the buyer. The signing instruction may be implemented to log on to a system terminal and to enter a user identification for reviewing the contract and for signing the contract. The contract may be performed by the provider and a bill may be transmitted to the buyer at a system terminal. A payment may be released for the contract to the provider at a system terminal.

These and other features, aspects and advantages of the present invention will become better understood with reference to the following drawings, description and claims.

### BRIEF DESCRIPTION OF THE DRAWINGS

FIG. 1 illustrates a graphical representation of the contract execution system according to an embodiment of the invention;

FIG. 2 illustrates a flow diagram of a process according to an embodiment of the invention;

FIG. 3 illustrates a lien waiver instruction according to an embodiment of the invention;

FIG. 4 illustrates a lien waiver document according to an embodiment of the invention;

FIG. 5 illustrates a data base report according to an embodiment of the invention;

FIG. 6 illustrates a data base report according to an embodiment of the invention;

FIG. 7 illustrates a data base report according to an embodiment of the invention;

FIG. 8 illustrates a data base report according to an embodiment of the invention;

FIG. 9 illustrates a flow diagram of a process according to an embodiment of the invention;

FIG. 10 illustrates a change order document according to an embodiment of the invention.

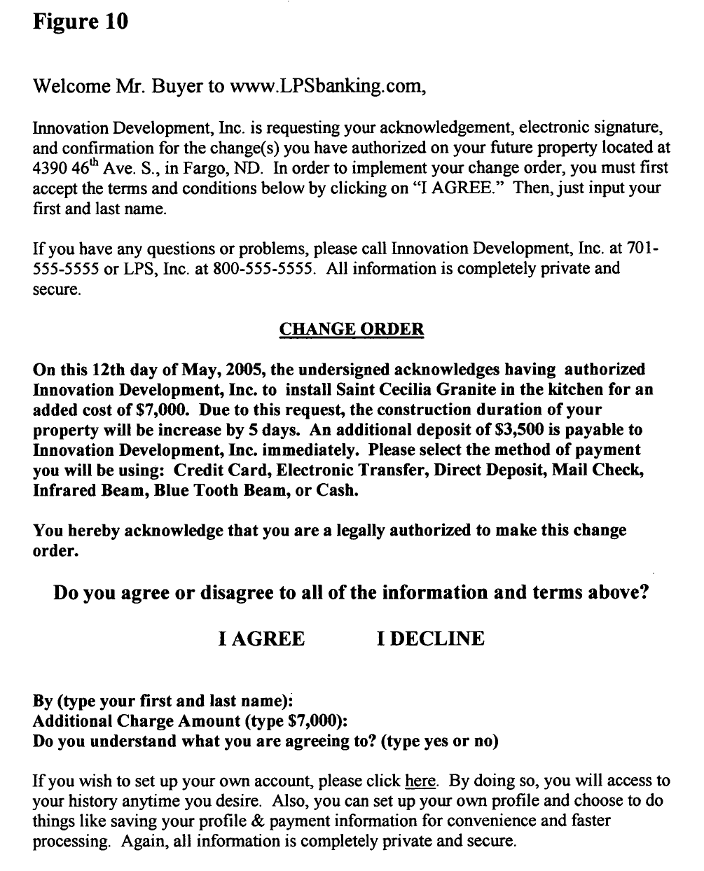

### DETAILED DESCRIPTION

The following detailed description represents the best currently contemplated modes for carrying out the invention. The description is not to be taken in a limiting sense, but is made merely for the purpose of illustrating the general principles of the invention.

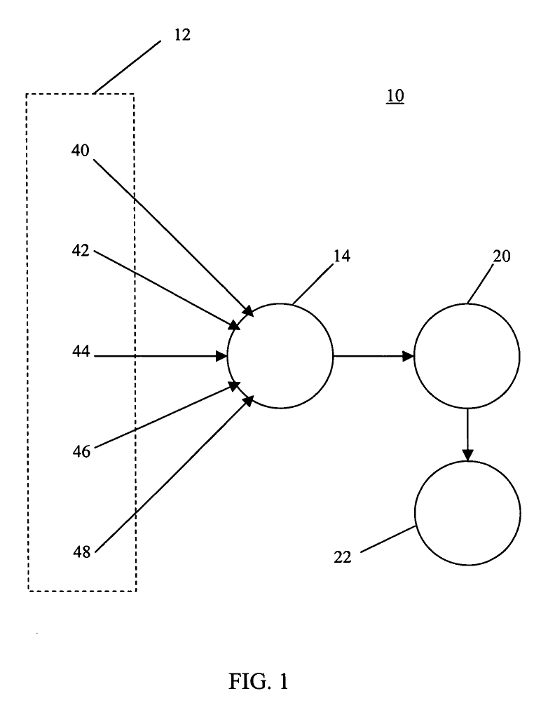

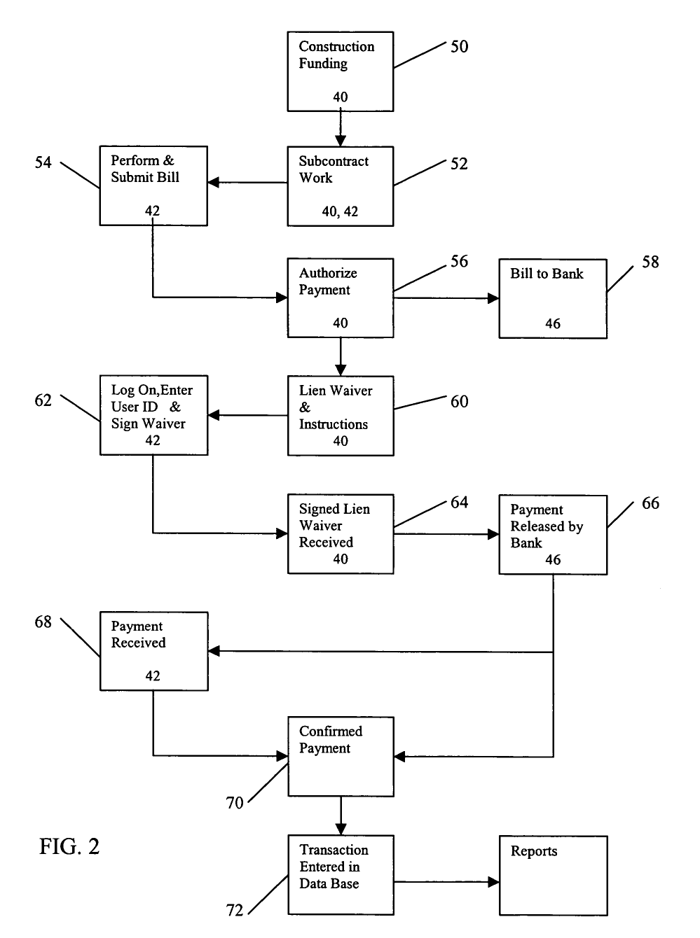

Referring to FIGS. 1 and 2, a contract execution system and process 10 may have a central operating and data base element 20 that may be operated by a bank, escrow company, lending institution, funds handling entity or like business or service organization. A user 12 that may be a contractor 40, a subcontractor 42, a buyer 44, a lender 46, a bank examiner or the like contracting entity who may then interact with the central element 20 to enter into contractual agreements and to execute elements of contractual agreements, for example, payment for work performed, execution of lien waiver documents, documenting changes to a contract, payment for change orders as well as other contractual elements.

The user 12 may access the central element 20 from system terminals 14 that may be remote and that may be data terminals at banking or other business entities, remote terminals linked to the Internet or other network systems, telephone system terminals or voice devices, blue tooth communication systems and the like. These remote terminals 14 may be linked by wire, radio wave, satellite, infrared or other transmission methods. Mail and courier type services may also be used for some elements of a contract process 10 where electronic methods may not be available or efficient for a particular user 12 or system operation.

In use the contract execution system and process 10 may have a distributed central operating and data base element 20 as for example a bank and an escrow company may manage certain portions of the process and coordinate maintenance of the data base for various contract processing functions. An example of a use of the system may be the funding of a construction process as illustrated in FIG. 2. A contractor 40 may obtain funds 50 from a lending institution such as a bank 46 or may be self funding. The contractor 40 may hire subcontractors 42 to perform work 52 on the construction project. Once the subcontractor 43 has completed the work a bill for payment 54 may be submitted. These steps or actions may all be taken without the parties meeting. For example, the contractor 40 may have a relationship or agreement with a bank 46 to prepare loan documents electronically at a terminal 14 that may then be processed and approved at the bank 46. The subcontractor 42 may be on an approved list of companies for work for the contractor 40 and a work order or contract may be electronically transferred from the contractor 40 to the subcontractor 42 who may then use an electronic signature to sign the contract. The approved list may be based on a rating system reflecting a subcontractor's 40 performance history, as an example, lien waiver completion action and job performance. Once the work is performed the subcontractor 42 may submit the bill 54 electronically to be received electronically 56 by the contractor 40 who may normally be the payer of the bills, or other entities 58 that may be designated, such as, an accountant, a bank 46, or an escrow company. All of these transactions may be maintained in a database 22 of the central operating and data base element 20.

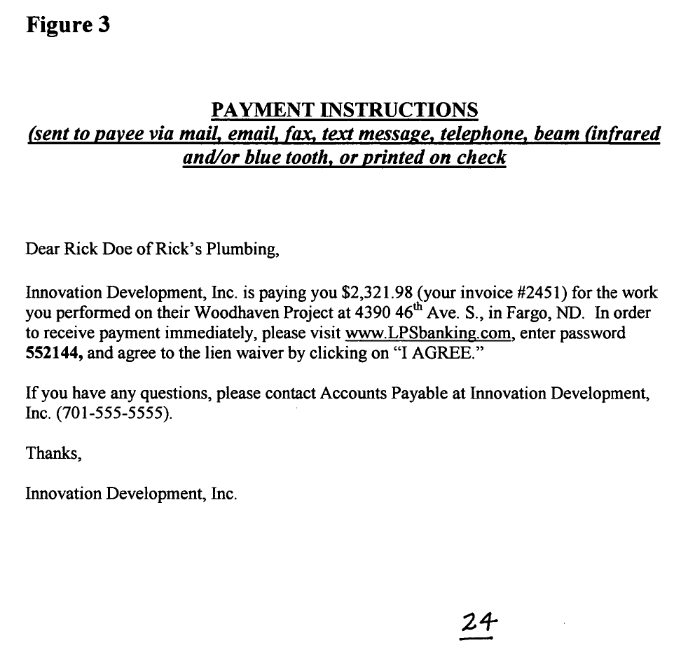

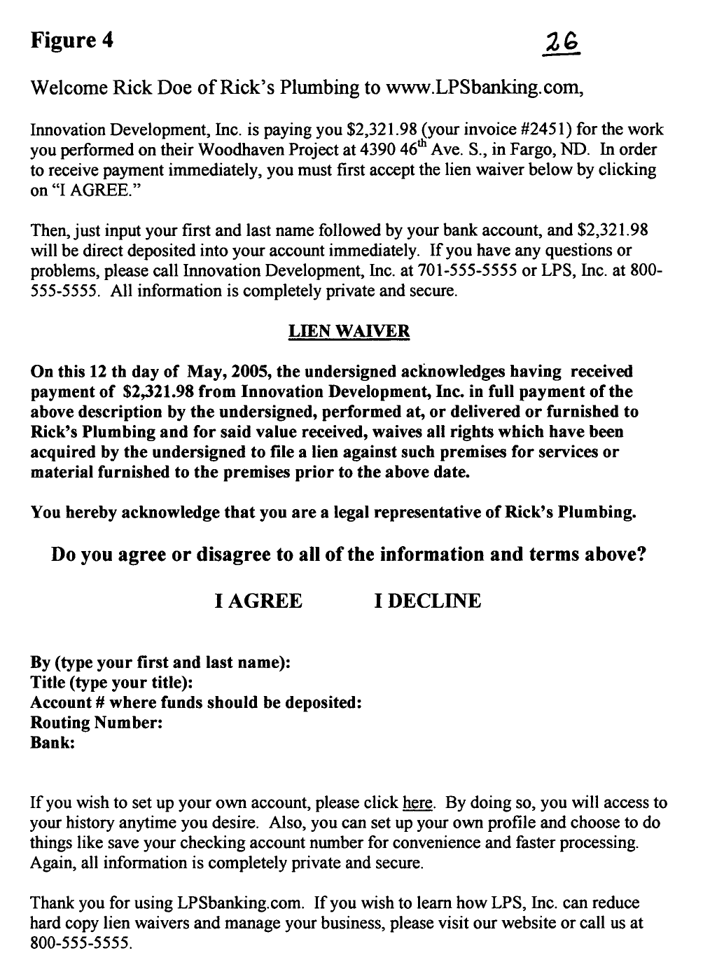

The contractor 40 may authorize payment of funds 56 by the contractor's bank 46, an accountant or other designated entity based on the work performed and conditioned on the subcontractor 42 signing a lien waiver. The contractor 40 may prepare a lien waiver document with instructions 60 to be transmitted electronically to the subcontractor 42. The contractor 40 may authorize payment of funds 56 to the subcontractor 42 conditioned on receipt of a signed lien waiver 64. The instructions 24 and lien waiver document 26 may be as illustrated in examples in FIGS. 3 and 4. The instructions 24 may contain an electronic address such as an Internet web site and user identification that may be a pass code or password to allow access to the central element 20 for the subcontractor 42 to review the lien waiver 26 and to electronically sign or agree to the document 62. If an electronic notary may be necessary, this may also be accomplished with the signing. While the embodiment discloses the contractor 40 as preparing documents and verifying payments, other entities may also be authorized to do so, for example, if a lender such as a bank 46, title company, escrow company or the like may be involved in the transaction, they may prepare lien waiver forms and signing instructions and transmit them as well a verifying receipt of documents.

If the subcontractor 42 may not have their own terminal access for performing 62, they may have access arranged through their own bank or an escrow type entity, they may use the bank 46 that may be part of the system, or they may use other types of electronic service providers. Other types of execution methods may also be used, for example, the lien waiver and instructions 60 may be transmitted by mail or courier to the subcontractor 42 with user identification information and the subcontractor 42 may then use a voice or text system such as a telephone to authenticate themselves and execute the lien waiver 26. The transaction data may be entered in the database 22 by a contract execution system manager that may be a bank 46, an entity that may operate contract execution type systems, or a contractor 40, by personnel conversing with the subcontractor 42. For more sophisticated voice systems, as an example, a voice recording may be used to authenticate acceptance of a lien waiver 26 that may eliminate personal contact with contract execution system manager personnel. Other electronic identification may also be used, for example, biometric identification may be used that may be electronic fingerprint or eye identification type systems.

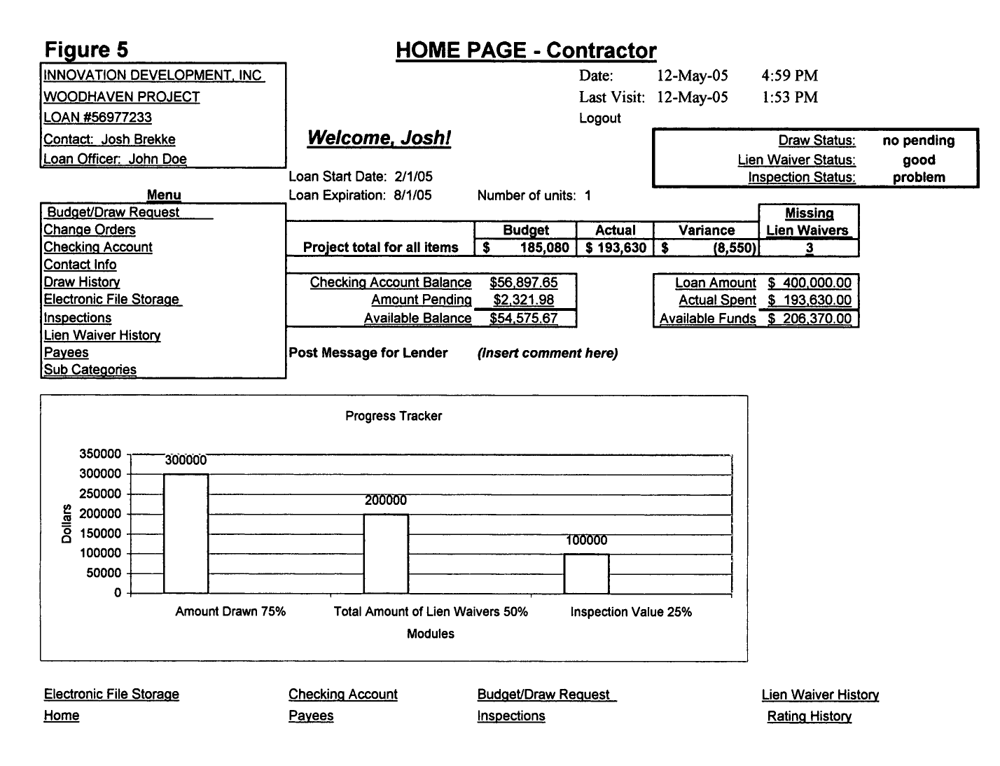

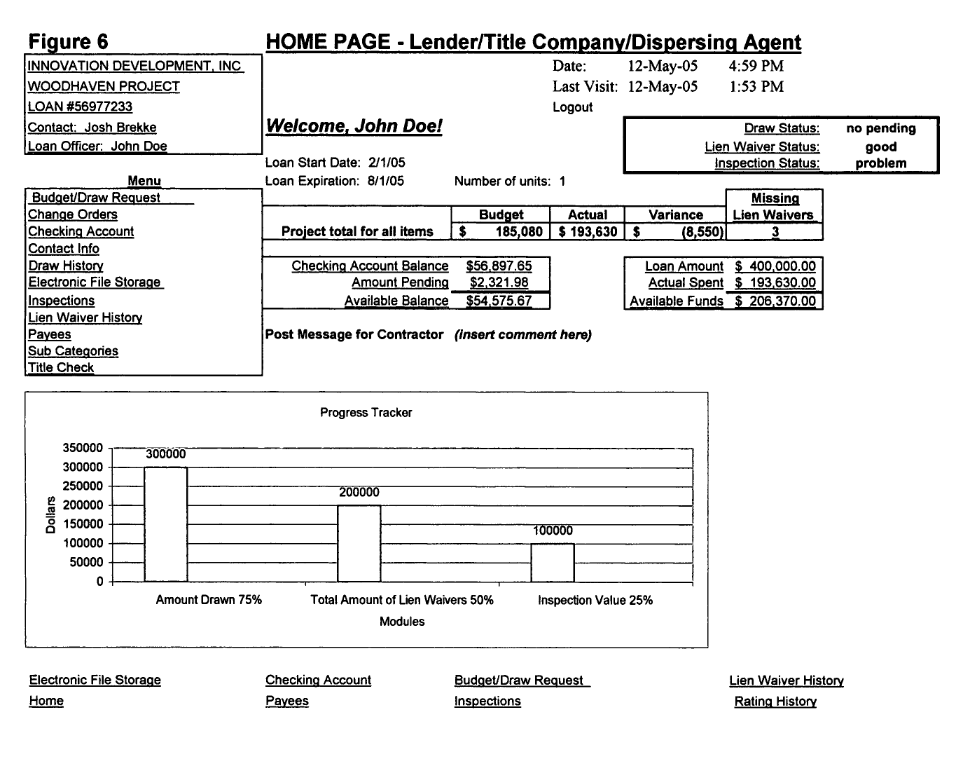

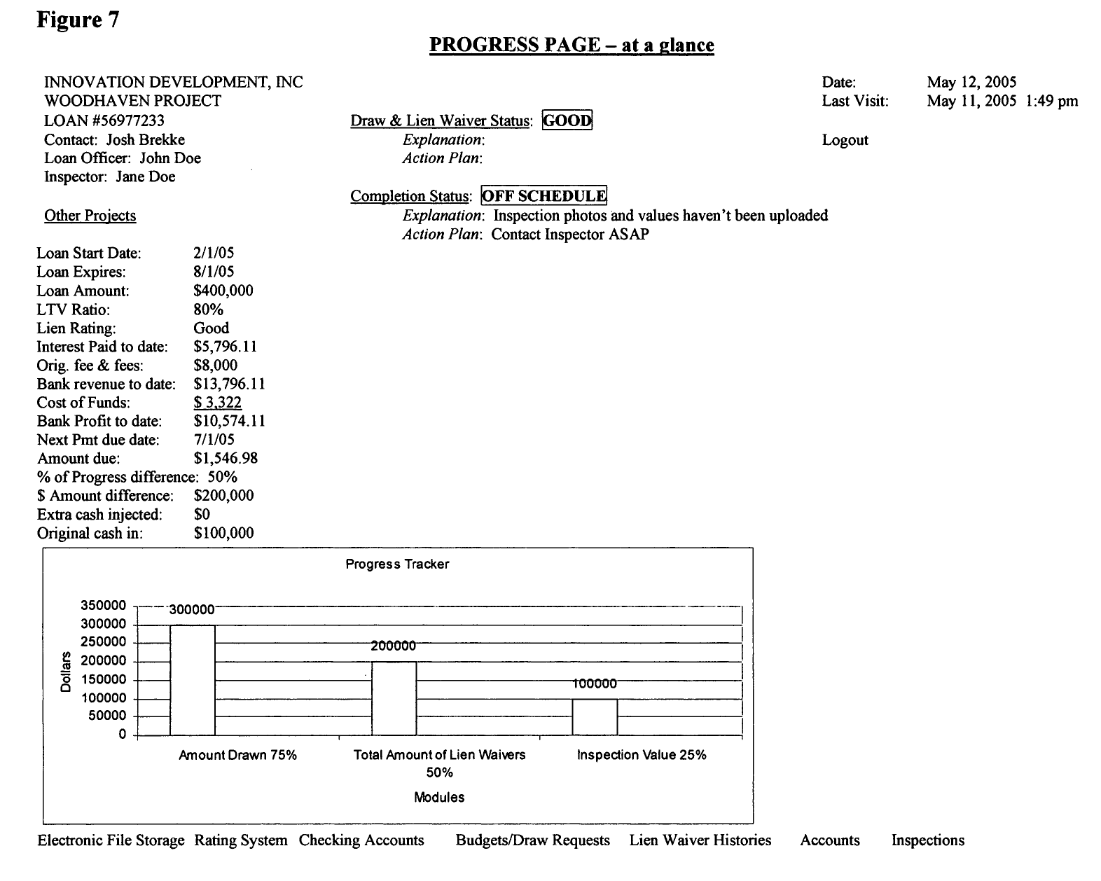

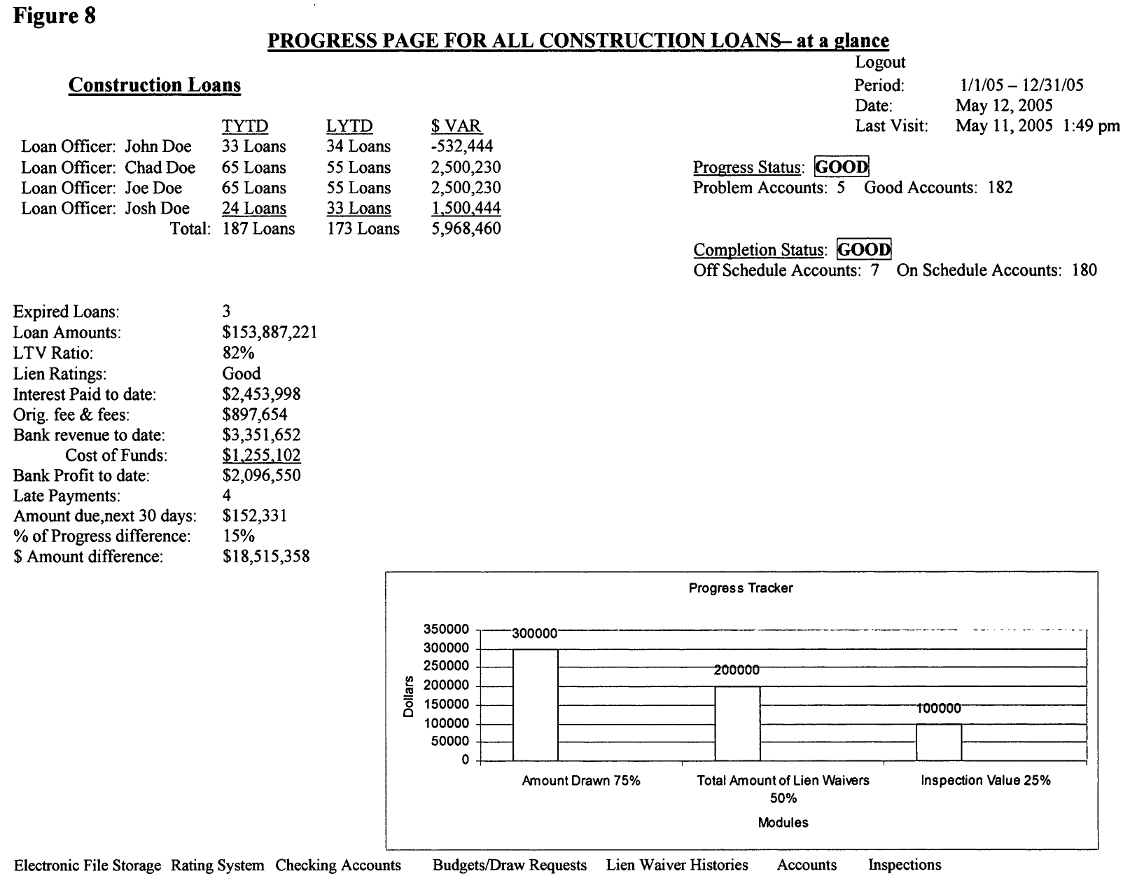

When the subcontractor 42 signs the lien waiver 62 the central element 20 may recognize this event 64 and depending on the remote terminal 14 capabilities of the subcontractor 42, an electronic check may be produced or enabled at a local terminal that may be printed, an electronic funds transfer or direct deposit may be effected, a check may be mailed, or other manner of payment initiated 66. Receipt of payment 68 may be confirmed 70 electronically or by return of a canceled check, receipt or other document. The completion of the subcontractor 42 transaction may then be entered 72 in the data base 22. This process may be used with multiple subcontractors on one or more construction projects for the contractor 40, lender 46, inspectors and others to monitor progress of projects and correlate payments to lien waiver status. Depending on the control of the central element 20, that is, contractor 40, lender 46, or other entity, access to date in the database 22 may be authorized for users on a need to know basis. For example, a contractor 40 may be allowed access to data associated with its subcontracts as a means for tracking work progress, payments, lien waiver history and other information. Examples of possible types of reports are illustrated in FIG. 5 through 8.

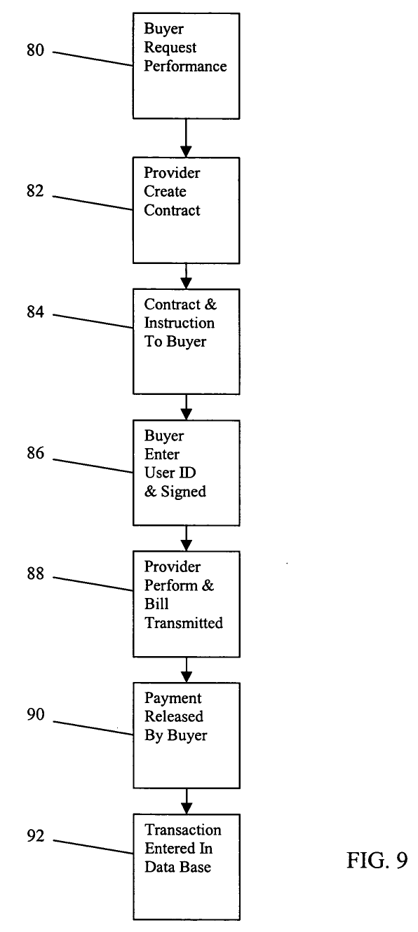

Referring to FIGS. 1 and 9, the contract execution system and process 10 may be used for other elements of contracting to develop documents and confirm execution of agreements or performance to validate payment for work, services or products. A party wishing performance such as a buyer, a seller or a payer wishing a performance may contact a provider such as a contractor 80. The provider may create a contract document 82 as for example a change order for a construction contract or purchase order on the central element 20. The contract document may be transmitted with instruction 84 for the buyer to review and sign 86 the contract document, for example, change order or purchase order similar to steps 60 and 62 as described herein for the lien waiver process. Once the contract may be performed by the provider a bill may be submitted to the buyer 88 and payment may be released by the buyer 90 similar to step 66 as described herein for the lien waiver process. Contract performance payment between the parties may involve other than money payments, for example, the provider may perform and the buyer may pay by performing an agreed service or commodity exchange as payment. The users of the central element 20 may control or establish reports to provide contract status information similar to that described for use in the system for the lien waiver process. The results of the transaction may be entered in a data base 92. While this embodiment has been described for a transaction involving a contractor performance, the provider 80 may be a seller or other entity wishing to contract with a party wishing a type of performance, for example, a joint venture, a sale or other type of transaction in which the electronic contract system and method may be applied.

While the invention has been particularly shown and described with respect to the illustrated embodiments thereof, it will be understood by those skilled in the art that the foregoing and other changes in form and details may be made therein without departing from the spirit and scope of the invention.

I claim:

1. A method for contract preparation and performance payment comprising:
a) initiating a request for a performance to a provider by a buyer;
b) creating a contract by said provider at a first system terminal of a central operating and data base element for said performance;
c) transmitting said contract with a signing instruction to said buyer;
d) implementing said signing instruction to log on a second system terminal and to enter a user identification for reviewing said contract and for signing said contract;
e) performing said contract by said provider and transmitting a bill to said buyer at said first system terminal; and
f) releasing a payment for said contract to said provider at said second system terminal.

2. The method as in claim 1 wherein after the releasing a payment a transaction record is entered in a data base of said central operating and data base element.

3. The method as in claim 1 wherein said transmitting said contract is by an electronic transmission.

4. The method as in claim 1 wherein said transmitting said contract is by courier.

5. The method as in claim 1 wherein said signing said contract is by an electronic signature.

6. The method as in claim 1 wherein said signing said contract is by a biometric identification system.

7. The method as in claim 1 wherein said signing said contract is by a voice telephonic system.

8. The method as in claim 1 wherein said signing said contract is by a video conference transmission system.

9. A method for contract performance and lien waiver execution comprising:
a) providing funds by a contractor;
b) contracting by said contractor with a subcontractor to perform work;
c) performing said work by said subcontractor and submitting a bill at a first system terminal of a central operating and data base element;
d) receiving said bill by said contractor;
e) authorizing a payment of funds for said bill at a second system terminal by said contractor;
f) creating and transmitting by said contractor a lien waiver form and a signing instruction for said lien waiver form and for receiving said payment of funds by said subcontractor at said first system terminal;
g) authorizing said payment of funds at said second system terminal by said contractor conditioned on receipt of said lien waiver form signed by said subcontractor;
h) implementing said signing instruction by said subcontractor to log on said first system terminal and to enter a user identification for receiving said lien waiver and for signing said lien waiver;
j) receiving said lien waiver signed at by said contractor;
k) releasing said payment of funds at a third system terminal;
l) receiving said payment of funds by said subcontractor; and
m) confirming said payment of funds by said contractor.

10. The method as in claim 9 wherein after confirming said payment of funds a transaction record is entered in a data base of said central operating and data base element.

11. The method as in claim 9 wherein providing said funds is said contractor obtaining a loan from a lender, said bill is received by said lender, said creating and transmitting is by said lender, and said signed lien waiver is received by said lender.

12. The method as in claim 9 wherein said transmitting by said contractor is by an electronic transmission.

13. The method as in claim 9 wherein said transmitting by said contractor is by mail

14. The method as in claim 9 wherein said signing said lien waiver is by electronic signature.

15. The method as in claim 14 wherein said electronic signature is authenticated by an electronic notarization.

16. The method as in claim 9 wherein said signing said lien waiver is by a voice telephonic system.

17. The method as in claim 9 wherein said receiving said payment of funds is an electronic check at said first system terminal that is printable.

18. The method as in claim 9 wherein said receiving said payment of funds is a direct electronic transfer to a deposit account.

19. The method as in claim 9 wherein said receiving said payment of funds is receipt of a mailed check.

20. A system for contract preparation and performance reporting comprising:
a central operating and data base element in communication with a plurality of terminals; and
a program having a contract document creating element, a transmitting and receiving element, and an electronic signature element.
